(19) United States
(12) Patent Application Publication
(10) Pub. No.: US 2015/0120460 A1
(43) Pub. Date: Apr. 30, 2015

(54) Displaying Advertisement using Personal pictures

(71) Applicants: Jayakumar Chellaganapathysubramanian, Princeton, NJ (US); Ravi Chandra Karnam, Plainsboro, NJ (US); Ramesh Pichaiyan, Newtown, PA (US)

(72) Inventors: Jayakumar Chellaganapathysubramanian, Princeton, NJ (US); Ravi Chandra Karnam, Plainsboro, NJ (US); Ramesh Pichaiyan, Newtown, PA (US)

(73) Assignee: Ramesh Pichaiyan, Newtown, PA (US)

(21) Appl. No.: 14/164,186

(22) Filed: Jan. 25, 2014

Related U.S. Application Data
(60) Provisional application No. 61/894,925, filed on Oct. 24, 2013.

(51) Int. Cl. G06Q 30/02; G06Q 50/00

(52) U.S. Cl. CPC G06Q 30/0271; G06Q 30/0267; G06Q 50/01
USPC 705/14.64

(57) ABSTRACT

Displaying Advertisements on personal pictures over the web or mobile platform. Users can attach advertisements to their personal picture; they can do so by picking and choosing the Advertisements from any advertisement providers. These pictures, once shared, can be accessed through the web or any mobile platform.

### BACKGROUND OF THE INVENTION

1. Field of the Invention

This invention relates to field of software technology. More specifically, the invention comprises of displaying advertisements using personal pictures on the web or any mobile platform with the consent of Users.

2. Description of the Related Art

In the web and/or mobile platform, there are several ways to advertise products. Following are some of the existing mechanisms:
1. Search engines displays ads based on the search key word and depends on the premium paid to these engines the ads are ordered and given priority.
2. Display Ads based on the user activity, behavior and their historical activity.
3. Display Ads based on their interaction, products purchased and products searched with in their site.
4. Display ads based on social interaction and the key words they use with in the social site.
5. Display Ads when viewing video.

### BRIEF SUMMARY OF THE INVENTION

Web has evolved a lot in recent years and there is a huge shift in the way users interact and collaborate with each other's. This offers all users the same freedom to contribute and collaborate over the web. Addition of Social media helped users to improve the means of interactions among people in which they create, share, and/or exchange information and ideas in virtual communities and networks.

According to Wikipedia, Social media differentiates from traditional/industrial media in many aspects such as quality, reach, frequency, usability, immediacy, and permanence. For content contributors, the benefits of participating in social media have gone beyond simply social sharing to building reputation and bringing in career opportunities and monetary income.

Users are spending more and more time in social media by posting lot of content including their personal pictures and videos across the web. They are sharing this information with their family members, friends and relatives located across the world.

The sharing of information across the world over the web using personal content opens up new opportunity for users. If they wish to attach advertisements to their personal pictures they can do so by picking and choosing the Advertisements from any advertisement providers. In this process, they can also set time frame, frequency and expiry while embedding the Ads in their personal pictures. The pictures that users wanted to attach advertisements will be with the prior consent of the user.

### BRIEF DESCRIPTION OF THE DRAWINGS

Using this invention, following are some of the examples of displaying advertisements.

FIG. 1. FIG. 1 shows simple view, which flips user Personal Image with advertisement.

FIG. 2. FIG. 2 shows user Personal Image with multiple advertisements.

FIG. 3. FIG. 3 shows user Personal Image with advertisement stack.

FIG. 4. Flow diagram of the process

### DETAILED DESCRIPTION AND BEST MODE OF IMPLEMENTATION

As the users are spending more and more time in social media by posting lot of content including their personal pictures and videos across the web. They are sharing this information with their family members, friends and relatives located across the world. The sharing of information across the world over the web using personal content opens up new opportunity for users.

Users can attach advertisements to their personal pictures they can do so by picking and choosing the Advertisements from any advertisement providers. During this process, they can also set time frame, frequency and expiry while embedding the Ads in their personal pictures. The pictures that users wanted to attach advertisements will be with the prior consent of the user.

Individuals can target specific ads for their friends and family, which will be more accurate, as part of sharing their pictures. If a specific individual is more popular he can influence his audience by attaching ads to his personal picture. This opens up huge opportunities for various individuals and organizations. If a book author wants to advertise his new book he can do so by attaching his new book to his personal picture. If a school wants to raise some funding for an event they can attach ads to their school logo or some very important picture of the school.

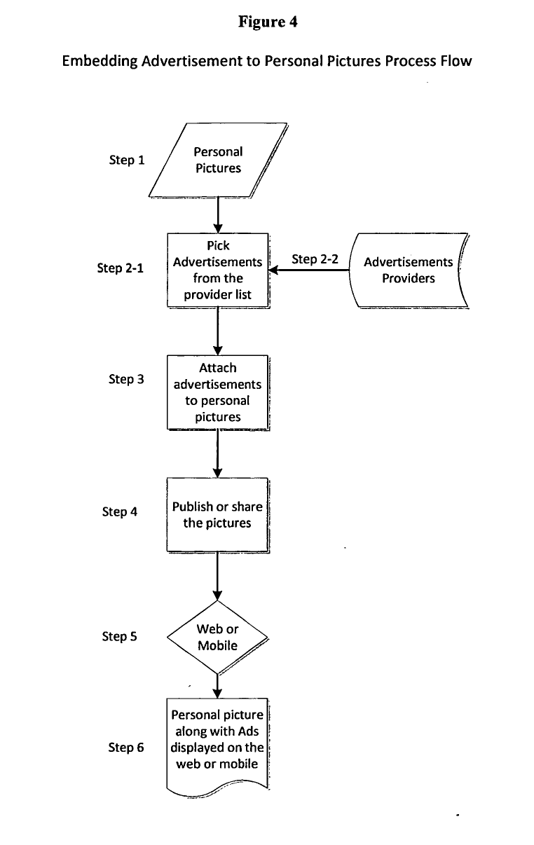

The flow diagram on FIG. 4 shows the process flow.

Step 1. Users are planning to share their personal pictures.

Step 2-1. They can pick the advertisements from the available list which are provided in step 2-2 by various providers.

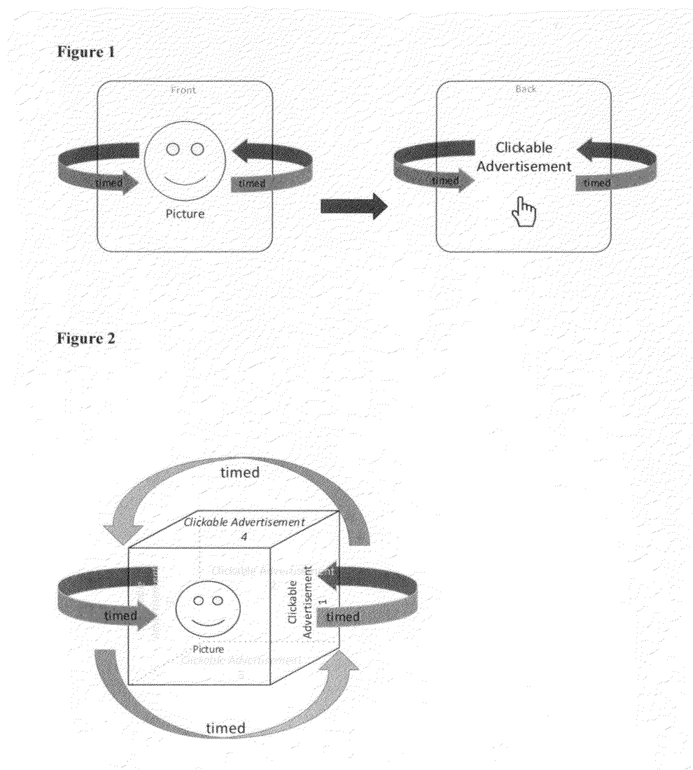

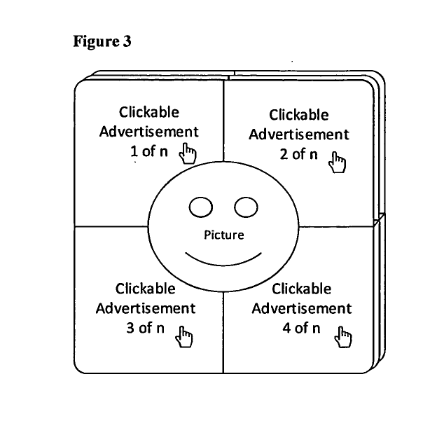

Step 3. Users can attach the advertisement chosen in step 2 to their personal picture step 1 using some of the formats mentioned in FIG. 1, FIG. 2 or FIG. 3.

Step 4. In this step users are sharing or publishing the picture from step 3.

Step 5. In this step the pictures are optimized for web or mobile platform to address various form factors.

Step 6. Personal picture along with advertisement displayed based on the web or mobile platform.

### REFERENCES (Incorporated Herein by Reference)

None.

Having described our invention, we claim:

1. Advertisements can be configured to personal pictures, comprising:
a. Pictures used on a world wide web.
b. Pictures used on any mobile device.
c. Pictures used in social media.
Users can also attach videos to their personal pictures.
